(19) United States
(12) Patent Application Publication
(10) Pub. No.: US 2011/0214338 A1
(43) Pub. Date: Sep. 8, 2011

(54) PEST DETERRENT SYSTEM

(75) Inventor: Tyson P. Neumann, Salt Lake City, UT (US)

(73) Assignee: CRIMSON PRIME ENTERPRISE, INC., Salt Lake City, UT (US)

(21) Appl. No.: 12/719,744

(22) Filed: Mar. 8, 2010

(51) Int. Cl. A01M 23/36; E04B 1/72

(52) U.S. Cl. 43/77; 52/101; 43/124

(57) ABSTRACT

Embodiments are directed to deterring pests using a user-customizable array of spikes buried under the surface of the ground. A system is provided for deterring pests using a user-customizable array of spikes buried under the surface of the ground. The system includes a lattice sheet with one or more interconnected segments, where each interconnected segment includes various recipient nodules configured to receive pest deterring spikes. In this way, the lattice sheet comprises a user-customizable array of pest deterring spikes. The pest deterring system also includes various pest deterring spikes, each of which is fastened orthogonally to at least one of the recipient nodules on the lattice sheet, so that the pest deterring spikes are positioned toward the ground surface.

### BACKGROUND

Gardens, flowerbeds and other landscape areas set apart for growing plants are commonly subject to disturbance by outside pests. Such pests may include cats, dogs or other animals which like to dig holes in the dirt, slugs or snails which eat the plants' leaves or insects which can infest and overcome a plant. In some cases, pests may also cause damage to the plants or landscape areas from beneath. For instance, burrowing animals such as gophers or groundhogs may dig holes, eat roots or otherwise destroy a garden or landscape area.

To prevent or at least deter the presence of such pests, various solutions have been presented. In some cases, electronically-controlled motion-activated devices play a sound or spray water to scare the would-be pest. In other cases, chemical solutions are used to deter the animals from visiting a certain area. For instance, insecticides or other sprays may be applied to the plants' leaves to deter animals from eating or chewing the leaves. Other solutions include pouring powders or other chemical agents on the ground to deter pests. Less harmful solutions include using distributing spices (such as pepper) or other smells that are known to be unpleasant to the animal.

### BRIEF SUMMARY

Embodiments described herein are directed to deterring pests using a user-customizable array of spikes buried under the surface of the ground. In one embodiment, a system for deterring pests using a user-customizable array of spikes buried under the surface of the ground includes a lattice sheet with one or more interconnected segments, where each interconnected segment includes various recipient nodules configured to receive pest deterring spikes. In this manner, the lattice sheet comprises a user-customizable array of pest deterring spikes. The pest deterring system also includes various pest deterring spikes, each of which is fastened orthogonally to at least one of the recipient nodules on the lattice sheet, so that the pest deterring spikes are positioned toward the ground surface.

In another embodiment, a method for deterring pests using a user-customizable array of subterranean spikes fastened to a lattice sheet is introduced. The method includes an act of fastening various pest deterring spikes to a lattice sheet, where the lattice sheet includes interconnected segments. Each interconnected segment includes recipient nodules configured to receive a pest deterring spike so that the lattice sheet comprises a user-customizable array of pest deterring spikes. The method also includes an act of burying the lattice sheet with the various fastened pest deterring spikes under the ground surface so that the pest deterring spikes are positioned toward the ground surface and are positioned to be substantially even with the ground surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a lattice sheet that includes interconnected segments and recipient nodules.

FIG. 2 illustrates a three-dimensional representation of a lattice sheet that includes interconnected segments and recipient nodules.

FIGS. 3A & 3B illustrate various embodiments of pest deterring spikes.

FIGS. 4A, 4B & 4C illustrate three-dimensional representations of various embodiments of pest deterring spikes.

FIGS. 5A & 5B illustrate side views of a lattice sheet with (optional) pest deterring spikes attached thereto.

FIG. 6 illustrates a flowchart of an example method for deterring pests using a user-customizable array of subterranean spikes fastened to a lattice sheet.

FIGS. 7A & 7B illustrate connectors and connector regions for connecting lattice sheets.

### DETAILED DESCRIPTION

Embodiments described herein are directed to deterring pests using a user-customizable array of spikes buried under the surface of the ground. In one embodiment, a system for deterring pests using a user-customizable array of spikes buried under the surface of the ground includes a lattice sheet with one or more interconnected segments, where each interconnected segment includes various recipient nodules configured to receive pest deterring spikes. In this manner, the lattice sheet comprises a user-customizable array of pest deterring spikes. The pest deterring system also includes various pest deterring spikes, each of which is fastened orthogonally to at least one of the recipient nodules on the lattice sheet, so that the pest deterring spikes are positioned toward the ground surface.

In another embodiment, a method for deterring pests using a user-customizable array of subterranean spikes fastened to a lattice sheet is introduced. The method includes an act of fastening various pest deterring spikes to a lattice sheet, where the lattice sheet includes interconnected segments. Each interconnected segment includes recipient nodules configured to receive a pest deterring spike so that the lattice sheet comprises a user-customizable array of pest deterring spikes. The method also includes an act of burying the lattice sheet with the various fastened pest deterring spikes under the ground surface so that the pest deterring spikes are positioned toward the ground surface and are positioned to be substantially even with the ground surface.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

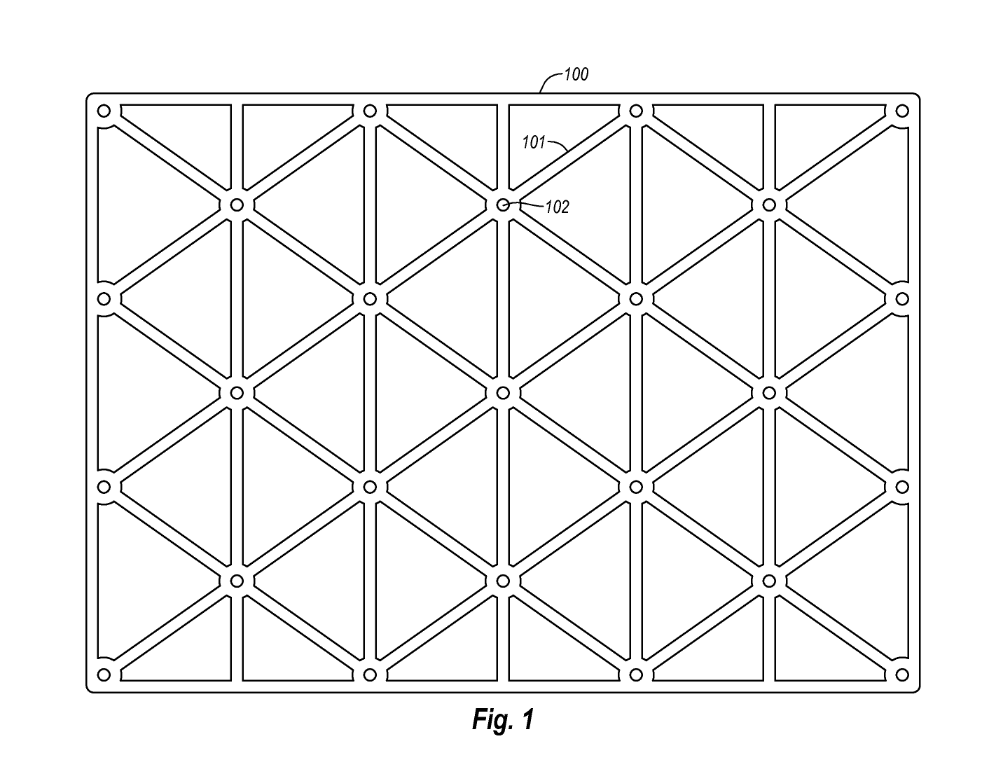

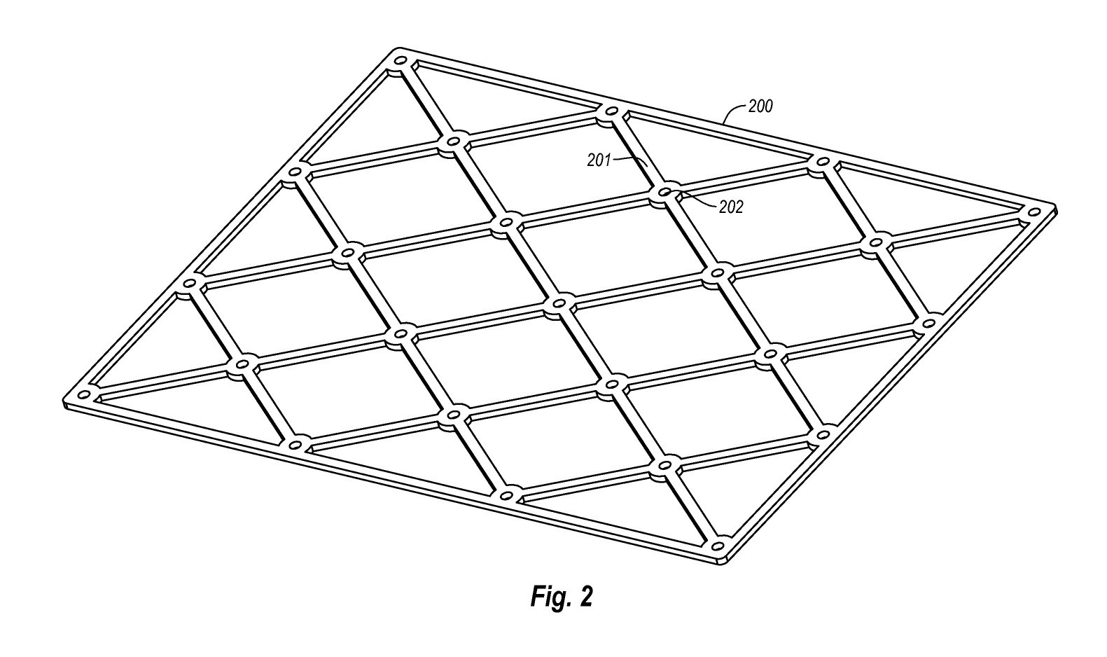

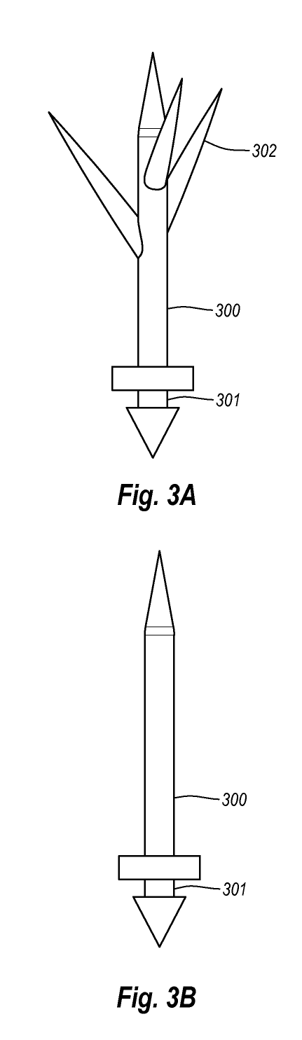

As described herein below, systems, methods and apparatuses for deterring pests are provided. As illustrated in FIG. 1, a lattice sheet 100 is provided into which pest deterring spikes may be fastened. For instance, pest deterring spikes as shown in FIGS. 3A and 3B may be fastened to the lattice using the recipient nodules 102. The lattice may include any number of recipient nodules 102 or interconnected segments 101. The lattice may be formed in substantially any shape, length, height or width. In some cases, the recipient nodules may include connectors that allow a user to connect as many or as few interconnected segments as the user desires. Such customizability would also allow a user to shape the lattice in substantially any form desired.

As shown in FIG. 1, the lattice sheet 100 includes seven columns and seven rows of recipient nodules 102, where each column or row has either three or four nodules. As indicated above, this is just one embodiment among many different possibilities. The lattice sheet shown in FIG. 1 is merely an example and it will be understood by one skilled in the art that many different variations are possible including more or fewer interconnected segments 101, more or fewer recipient nodules 102 and more or fewer edge pieces. The lattice sheet may be produced using any number of different materials including plastics such as polypropylene, ceramic, metal or other materials that would support pest deterring spikes.

Pest deterring spikes 300 may similarly be produced using materials such as plastic, ceramic, metal or other materials stiff enough to provide a nuisance when stepped on. The spikes may have a connecting region 301 which, as shown in FIGS. 3A & 3B, allows for a snap-fit connection. Accordingly, the triangle- or cone-shaped tip may be inserted into a recipient nodule and lock into place between the triangle/cone and an upper barrier section. The spikes may also include one or more prongs 302. The prongs may be arranged in different directions, thus increasing the amount of surface area protected by the spike. In some cases, the prongs may be produced such that all of the prongs end at substantially the same height. Thus, when the lattice sheet is buried in the ground, each of the spike prongs may be placed even with the ground surface.

As briefly mentioned above, the lattice sheet 100 may include any number of interconnected segments 101 or recipient nodules 102. At each of these recipient nodules, a pest deterring spike 300 may be attached. A user may attach spikes to any or all of the nodules, in any pattern the user desires. Accordingly, if a lattice sheet is buried under a certain length of ground and the user desires only to place spikes along certain portions of that stretch of ground (such as to go around a plant or other object), the user is able to do so. In this manner, the lattice sheet can be thought of as a user-customizable array of spikes, where each spike is placed by the user to protect those regions he or she wants to protect. The pest deterring spikes may be moved or rearranged as desired by the user.

In some cases, the lattice sheets may be produced as squares, rectangles or other shapes. A user may desire to link two or more of such sheets together. The user can do this using one or more lattice sheet connecting clips. The connecting clips may be configured to clip one edge segment to another edge segment or one interconnected segment to an edge segment or one interconnected segment to another interconnected segment. The connecting clips may also be corner connecting clips that connect lattice sheets at the corners. Other connecting clips may connect lattice sheets using the recipient nodules, either at the edge or elsewhere.

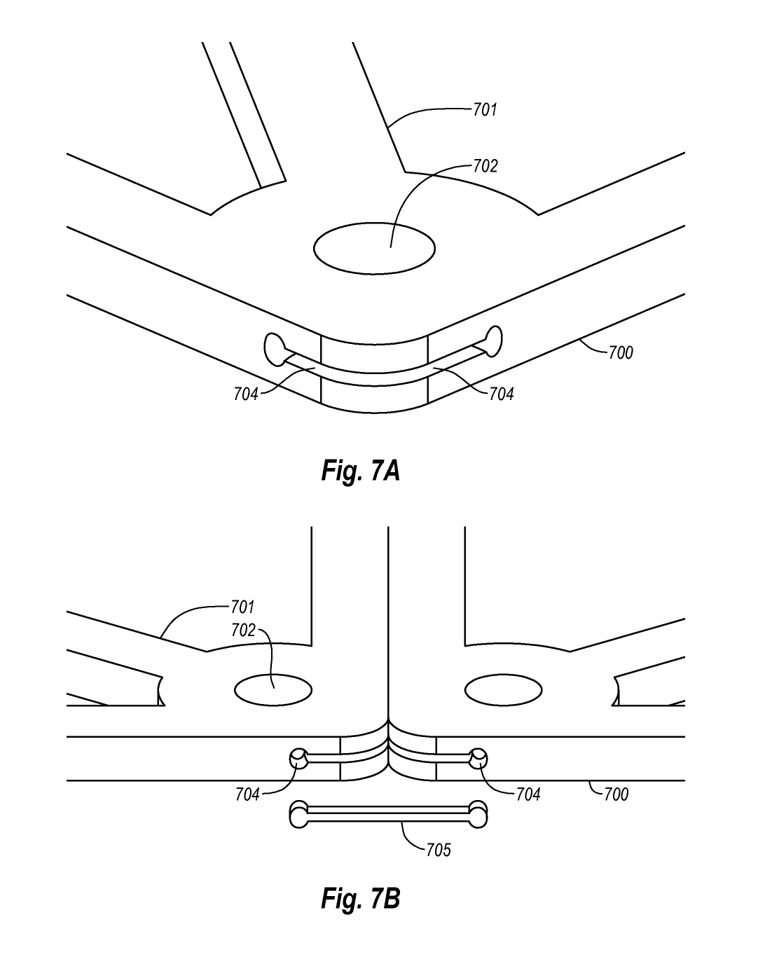

In the embodiments shown in FIGS. 7A and 7B, lattice sheet connecting clips 705 may be constructed as elongated pieces with bulbous portions on each end. These clips may be inserted in connection regions 704 which may be hollowed out cavities shaped in a similar manner as the connecting clips. Thus, the connecting clips 705 may be inserted into the connection grooves 704, fitting snugly into place. The clips may thus link two or more lattice sheets 700 together. The connecting clips 705, while shown as elongated pieces with bulbous ends, can be formed in substantially any shape and can have any size or shape portion attached to each end. For example, the connecting piece could have square-, rectangle-, oval- or other shaped portions at the end. These end portions keep the lattice sheets from sliding apart once connected. Thus, any shape or connecting design that would keep the sheets together may be used.

In some cases, a “+” shaped connector may be used to connect three or four lattice sheets together. It should also be noted that, while the connection regions 704 are shown at the corner of a lattice sheet, the connectors may be placed in substantially any portion of the lattice sheet including on the sides, as part of (or in place of) the recipient nodules 702, as part of (or in place of) an interconnected segment 701, or as part of or in place of any other portion of the lattice sheet.

In some embodiments, the lattice sheet 100 may comprise a substantially round shape for covering area surrounding a plant. For instance, the lattice may be donut-shaped such that the lattice surrounds the plant while leaving room in the middle for the plant and its roots. It should be noted that the lattice sheet is configured to allow water to drain between the lattice sheet segments, thus preventing problems created due to a lack of water drainage. The pest deterring spikes may be fastened orthogonally to at least one of the recipient nodules of the donut- or ring-shaped lattice sheet. In this way, the pest deterring spikes are positioned toward the ground surface and would be a nuisance to any animal that stepped thereon.

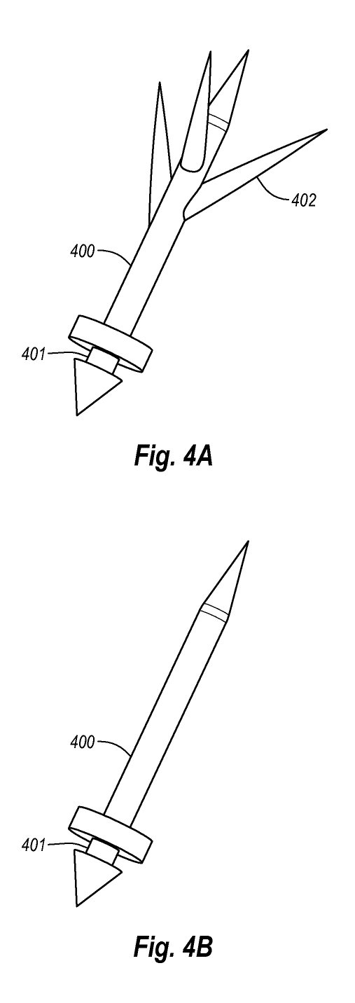

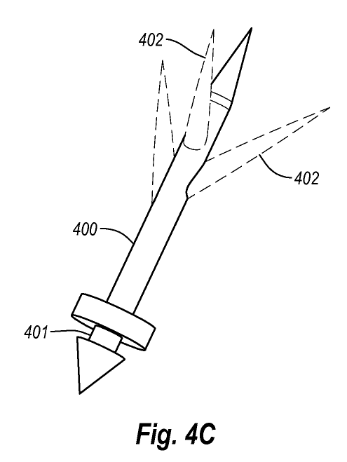

In some cases, the pest deterring spikes 300 may be positioned downward, away from the ground surface to deter burrowing pests. Accordingly, when the spikes are arranged in a downward fashion, the burrowing pests would encounter the spikes as they burrowed upward. Upon encountering the spikes, the burrowing pest would be deterred from digging in that spot. As mentioned previously, each of the spikes may have one or more prongs. These prongs may be customizable to allow the user to bend or otherwise change the directionality and/or length of the prongs. This allows the user to completely customize the area that is being covered by the pest deterring spikes and allows heavier coverage (e.g. more spikes) in some areas and less in others. Moreover, the spikes and/or prongs may be spread out to cover a larger surface area or concentrated to cover a smaller area more densely. It should also be noted that any number, size or shape of prongs may be included, as shown in FIG. 4C.

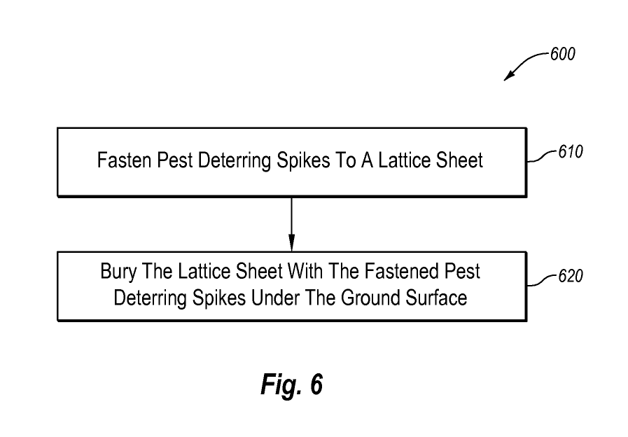

In view of the systems and apparatuses described above, methodologies that may be implemented in accordance with the disclosed subject matter will be better appreciated with reference to the flow chart of FIG. 6. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 illustrates a flowchart of a method 600 for deterring pests using a user-customizable array of subterranean spikes fastened to a lattice sheet. The method 600 will now be described with frequent reference to the components of FIGS. 1, 3A and 3B.

Method 600 includes an act of an act of fastening one or more pest deterring spikes to a lattice sheet, the lattice sheet comprising one or more interconnected segments, wherein each interconnected segment comprises one or more recipient nodules configured to receive a pest deterring spike, such that the lattice sheet comprises a user-customizable array of pest deterring spikes (act 610). For example, a user may fasten one or more pest deterring spikes 300 to lattice sheet 100. The lattice sheet includes interconnected segments 101, where each interconnected segment includes various recipient nodules configured to receive and hold a pest deterring spike. In this manner, the lattice sheet itself is fully customizable by connecting the interconnected segments in any fashion desired by the user. Similarly, the area protected by the spikes is also fully customizable by allowing the user to connect the spikes and/or change the spike prongs as he or she desires.

As mentioned above, multiple different lattice sheets (possibly of differing shapes and sizes) may be connected using one or more lattice sheet connecting clips. These clips may connect to any part of the lattice sheet including the recipient nodules 102, the interconnected segments 101 or an edge segment.

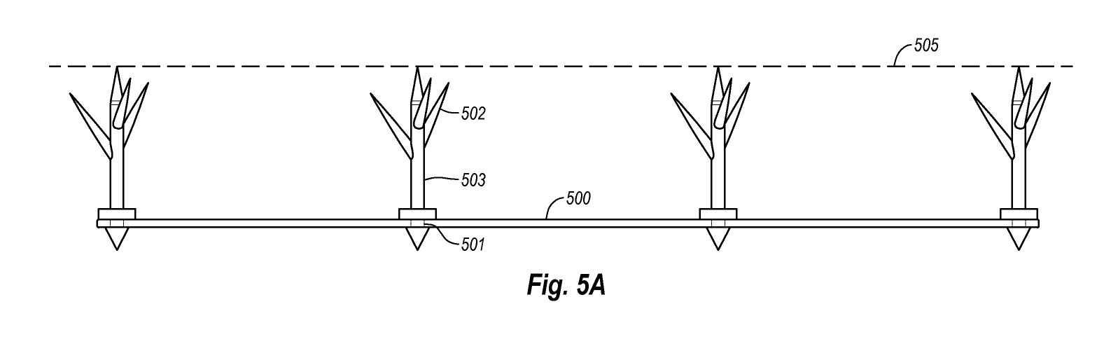

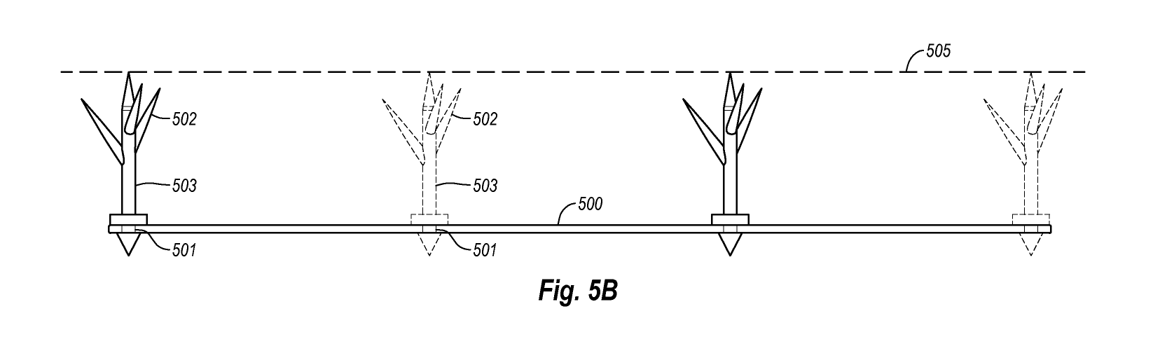

Method 600 also includes an act of an act of burying the lattice sheet with the one or more fastened pest deterring spikes under the ground surface such that the pest deterring spikes are positioned toward the ground surface and are positioned to be substantially even with the ground surface (act 620). For example, as shown in FIG. 5A, the lattice sheet 500, along with the pest deterring spikes (e.g. 503), may be buried in the ground such that the spikes and the spike prongs 502 are substantially level with the ground surface 505. In some cases, it may be desirable to have the spikes and/or prongs above or below the ground surface. This can be accomplished by burying (all or a portion of) the lattice sheet at (a) different depth(s).

The pest deterring spikes 503 may be fastened to the lattice sheet 500 using any of a variety of different fastening techniques or materials. Such techniques and materials include the following: adhesive, metal fasteners, screws, nuts and bolts or a snap-fit shape such that the spike snaps into place when inserted into the receiving nodule. As shown in FIG. 5A, the spikes are fastened to the lattice sheet using a snap-fit shape so that the upper barrier 501 rests on top of the lattice sheet and the cone or triangle portion rests below the lattice sheet. Burial in dirt, gravel or other material will also lend stability to the pest deterring spikes. As shown in FIG. 5B, any number of spikes may be added or removed (as indicated by the spikes represented in dotted-line form).

FIGS. 2, 4A, 4B and 4C attempt to show embodiments of the present invention in three-dimensional form. Elements with similar numbering may or may not refer to the same elements as in FIGS. 1, 3A and 3B. Accordingly, FIG. 2 includes lattice sheet 200 with interconnected segments 201 and recipient nodules 202. FIGS. 4A & 4C includes pest deterring spike 400 along with fastener 401 and prongs 402. FIG. 4B includes pest deterring spike 400 along with fastener 401. It should be noted that while lattice sheet 100 of FIG. 1 and lattice sheet 200 of FIG. 2 show different designs and/or different numbers of interconnected segments, either lattice sheet may include substantially any number of interconnected segments and/or recipient nodules. It will also be understood that these segments and nodules can be arranged in substantially any configuration. Moreover, any of the elements shown in these figures may be added or removed by a user or product manufacturer.

Thus, systems, apparatuses and methods are provided for deterring pests. A lattice sheet is provided to which various pest deterring spikes may be attached. The lattice sheet, along with the fastened spikes, is buried in the ground for which protection is desired. Pests are then deterred from the protected area as the spikes make walking on the area undesirable.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system for deterring pests using a user-customizable array of spikes buried under the surface of the ground, the system comprising:
a lattice sheet comprising one or more interconnected segments, wherein each interconnected segment comprises one or more recipient nodules configured to receive a pest deterring spike, such that the lattice sheet comprises a user-customizable array of pest deterring spikes; and
one or more pest deterring spikes, each of which is fastened orthogonally to at least one of the recipient nodules on the lattice sheet, such that the pest deterring spikes are positioned toward the ground surface.

2. The system of claim 1, wherein the lattice sheet is buried below ground surface such that the ends of the pest deterring spikes are substantially level with the ground surface.

3. The system of claim 1, wherein multiple lattice sheets are connected together using one or more lattice sheet connecting clips.

4. The system of claim 1, wherein the lattice sheet is configured to allow water to drain between the lattice sheet segments.

5. The system of claim 1, wherein the lattice sheet comprises a substantially round shape for covering area surrounding a plant.

6. The system of claim 1, wherein at least one of the pest deterring spikes is positioned downward, away from the ground surface to deter burrowing pests.

7. The system of claim 1, wherein at least one of the pest deterring spikes comprises a plurality of prongs.

8. The system of claim 7, wherein the plurality of prongs is spread out to protect a substantially larger surface area.

9. The system of claim 8, wherein the layout of the prongs is user-customizable such that the user determines how the prongs are to be spread out.

10. The system of claim 9, wherein at least the relative directionality and relative height are changeable by the user.

11. The system of claim 1, wherein the pest deterring spikes are comprised substantially of at least one of the following: plastic, metal and ceramic.

12. The system of claim 1, wherein the interconnected segments of the lattice sheet are individually connectable or disconnectable such that the lattice sheet itself is user-customizable.

13. A method for deterring pests using a user-customizable array of subterranean spikes fastened to a lattice sheet, the method comprising:
an act of fastening one or more pest deterring spikes to a lattice sheet, the lattice sheet comprising one or more interconnected segments, wherein each interconnected segment comprises one or more recipient nodules configured to receive a pest deterring spike, such that the lattice sheet comprises a user-customizable array of pest deterring spikes; and
an act of burying the lattice sheet with the one or more fastened pest deterring spikes under the ground surface such that the pest deterring spikes are positioned toward the ground surface and are positioned to be substantially even with the ground surface.

14. The method of claim 13, further comprising an act of connecting a plurality of lattice sheets using one or more lattice sheet connecting clips.

15. The method of claim 13, further comprising an act of positioning at least one of the pest deterring spikes in a downward position, away from the ground surface.

16. The method of claim 13, wherein the interconnected segments of the lattice sheet are individually connectable or disconnectable such that the lattice sheet itself is user-customizable.

17. The method of claim 16, further comprising an act of a user generating a customized lattice sheet by arranging the individually connectable interconnected segments and recipient nodules in a user-defined fashion.

18. The method of claim 17, further comprising an act of the user fastening one or more pest deterring spikes to the user-generated customized lattice.

19. A user-customizable pest deterring apparatus that includes the following:
a lattice sheet comprising one or more interconnectable segments, the segments of the lattice sheet being individually connectable or disconnectable such that the layout of the lattice sheet itself is user-customizable, wherein each interconnected segment comprises one or more recipient nodules configured to receive a pest deterring spike, such that the lattice sheet comprises a user-customizable array of pest deterring spikes;
one or more connecting clips for connecting the lattice sheet to at least one other lattice sheet; and
one or more pest deterring spikes, each of which is fastened orthogonally to at least one of the recipient nodules on the lattice sheet, such that the pest deterring spikes are positioned toward the ground surface.

20. The apparatus of claim 19, wherein the pest deterring spikes are fastened to the lattice sheet using at least one of the following: adhesive, metal fasteners, screws, nuts and bolts or a snap-fit shape such that the spike snaps into place when inserted into the receiving nodule.
